(19) United States
(12) Patent Application Publication
(10) Pub. No.: US 2025/0381828 A1
(43) Pub. Date: Dec. 18, 2025

(54) MOTOR ARRANGEMENT FOR POWER MACHINES

(71) Applicant: Doosan Bobcat North America, Inc., West Fargo, ND (US)

(72) Inventors: Jason Drost, Fort Atkninson, WI (US); Justin Stefanko, Waukesha, WI (US)

(21) Appl. No.: 19/240,768

(22) Filed: Jun. 17, 2025

Related U.S. Application Data
(60) Provisional application No. 63/660,613, filed on Jun. 17, 2024.

(51) Int. Cl. B60K 1/02; A01B 51/02; B60K 17/28; B60K 17/354; B60K 17/356; B60L 1/00; B60L 50/60; B62D 12/00

(52) U.S. Cl. CPC B60K 1/02; A01B 51/02; B60K 17/28; B60K 17/354; B60K 17/356; B60L 1/003; B60L 50/60; B62D 12/00; B60L 2200/40

(57) ABSTRACT

A tractor can include a frame that can include a front frame portion, and a rear frame portion that articulates relative to the front frame portion and an electric power source that can be supported by the frame. Tractive elements can be supported by the frame and configured to operate to move the tractor over terrain, including front tractive elements supported by the front frame portion and rear tractive elements supported by the rear frame portion. A plurality of electric motors can be supported by the frame. A first drive motor can be arranged to power one or more of the front tractive elements, and a second drive motor can be arranged to power one or more of the rear tractive elements.

### CROSS-REFERENCE TO RELATED APPLICATIONS

This application claims the benefit of U.S. Provisional Patent Application No. 63/660,613, filed Jun. 17, 2024, which is hereby incorporated by reference in its entirety.

### BACKGROUND

This disclosure is directed toward power machines. More particularly, this disclosure is directed towards systems of a power machine for power delivery, including for tractive, auxiliary, and external operations. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders (including mini-loaders), excavators, utility vehicles, mowers, tractors (including compact tractors and articulated compact tractors), and trenchers, to name a few examples.

Conventional power machines can include various systems and related components that are configured to use output from a power source (e.g., an electric motor) to perform different work functions. More specifically, the power source can transmit power to a power conversion system (e.g., a drive motor) to power a movement of a power machine or an implement or execute other operations.

The discussion above is merely provided for general background information and is not intended to be used as an aid in determining the scope of the claimed subject matter.

### SUMMARY

Power machines and related systems and methods as disclosed herein, including compact articulated tractors in particular, can include different systems to improve functionality and structure of the machine. For example, among other improvements, different implementations can provide power machines with improved arrangements of components of power conversion system, including drive motors, auxiliary motors, and power take-off (PTO) motors.

Some examples provide a tractor with a frame that includes a front frame portion, and a rear frame portion that articulates relative to the front frame portion. The frame can support an electric power source. The frame can further support tractive elements that are configured to operate to move the tractor over terrain. The tractive elements can include front tractive elements that are supported by the front frame portion and rear tractive elements that are supported by the rear frame portion. Additionally, the frame can support a plurality of electric motors that include a first drive motor arranged to power one or more of the front tractive elements and a second drive motor arranged to power one or more of the rear tractive elements.

In some examples, the first drive motor can be engaged with a front transaxle supported by the front frame portion. The first drive motor can provide power to a first front tractive element on a first lateral side of the tractor and a second on a second lateral side of the tractor.

In some examples, the first drive motor can extend reward of the front transaxle, relative to a front-to-back direction of the tractor. In some examples, the first drive motor can be cantilevered from the front transaxle.

In some examples, the second drive motor can be engaged with a rear transaxle supported by the rear frame portion. The second drive motor can provide power to a first rear tractive element on the first lateral side of the tractor and a second rear tractive element on the second lateral side of the tractor. In some examples, the second drive motor can extend above the rear transaxle. In some examples, the second drive motor can be arranged between the rear transaxle and an operator seat that is supported by the rear frame portion. The second drive motor can be arranged below at least part of the operator seat.

In some examples, the plurality of electric motors can include a third motor and a fourth drive motor. The first drive motor can be arranged to power a first front tractive element of the front tractive elements. The second drive motor can be arranged to power a first rear tractive element of the rear tractive elements. The third drive motor can be arranged to power a second front tractive element of the first tractive elements. The fourth drive motor can be arranged to power a second rear tractive element of the rear tractive elements.

In some examples, the plurality of electric motors can include a power take-off (PTO) motor arranged to power a PTO assembly supported by the frame. The plurality of electric motors can include an auxiliary motor arranged to power a hydraulic pump supported by the frame to power hydraulic operations for the tractor.

In some examples, the plurality of electric motors can include the PTO motor and the auxiliary motor. The first drive motor, the PTO motor, and the auxiliary motor can be supported by the front frame portion. The second drive motor can be supported by the rear frame portion.

Some examples provide a method of operating a power machine. An electric power source can be operated and supported by a frame of the power machine to power a plurality of electric motors that are also supported by the frame. The plurality of electric motors can include a first drive motor and a second drive motor. The frame can include a front frame portion and a rear frame portion that articulates relative to the front frame portion. The first drive motor can be controlled, with the first drive motor powered by the electric power source to power one or more front tractive elements that are supported on the front frame portion of the frame to move the tractor over terrain. The second drive motor can be controlled, with the second drive motor powered by the electric power source to power one or more rear tractive elements that are supported on the rear frame portion to move the tractor over terrain.

In some examples, the plurality of electric motors can include a power take-off (PTO) motor arranged to power a PTO assembly supported by the frame. The plurality of electric motors can include an auxiliary motor arranged to power a hydraulic pump supported by the frame to power hydraulic operations for the power machine. The method of operating the power machine can include controlling one or more of the PTO motor or the auxiliary motor to operate with variable speed to provide, respectively, one or more of a variable speed PTO output at the PTO assembly or variable speed operation of the hydraulic pump.

In some examples, controlling the one or more of the PTO motor or the auxiliary motor can include operating the PTO motor or the auxiliary motor independently of the first drive motor or the second drive motor.

In some examples, controlling the one or more of the PTO motor or the auxiliary motor can include operating the PTO motor independently of the auxiliary motor.

In some examples, controlling the first drive motor can include operating the first drive motor to rotate about an axis that extends in a front-to-rear direction, with the first drive motor cantilevered from a front transaxle supported on the front frame portion. Controlling the second drive motor can include operating the second drive motor to rotate about an axis that extends in upwardly, with the second drive motor cantilevered from a rear transaxle supported on the rear frame portion.

According to yet another aspect of the present disclosure, a power machine can include a frame including a first frame portion and a second frame portion that articulates relative to the first frame portion. The power machine can include an electric power source supported by the frame. The power machine can include a first transaxle supported by the first frame portion and a second transaxle supported by the second frame portion. The power machine can include a first electric motor supported by the first frame portion and cantilevered from the first transaxle to provide power to the first transaxle. The power machine can include a second electric motor supported by the second frame portion and cantilevered from the second transaxle to provide power to the second transaxle.

In some examples, the power machine can include a power take-off (PTO) assembly supported by the frame, including a PTO interface and a PTO motor configured to provide power to the PTO interface.

In some examples, the power machine can include a hydraulic pump supported by the frame and an auxiliary motor configured to power the hydraulic pump. The auxiliary motor can operate independently of one or more of the PTO motor, the first electric motor, or the second electric motor.

In some examples, the PTO motor and the auxiliary motor can be supported by the first frame portion. In some examples, the PTO assembly can include a pulley system.

This Summary and the Abstract can be provided to introduce a selection of concepts in a simplified form that can be further described below in the Detailed Description. This Summary and the Abstract are not intended to identify key features or essential features of the claimed subject matter, nor are they intended to be used as an aid in determining the scope of the claimed subject matter.

### DRAWINGS

The following drawings are provided to help illustrate various features of non-limiting examples of the disclosure and are not intended to limit the scope of the disclosure or exclude alternative implementations.

FIG. 1 is a block diagram illustrating functional systems of a representative power machine on which examples of the present disclosure can be advantageously practiced.

FIG. 2 is a block diagram illustrating components of a power system of a compact tractor or other configuration of the power machine of FIG. 1.

FIG. 3 illustrates a perspective view of a representative power machine in the form of a compact tractor.

FIG. 4 illustrates an axonometric view of a representative power machine in the form of a compact tractor, according to an implementation of the systems of FIGS. 1 and 2.

FIG. 5 is a side cross-sectional view of the compact tractor of FIG. 4, taken along a vertical mid-plane of the compact tractor.

FIG. 6 is an axonometric partial view of a front tractive assembly of the compact tractor of FIG. 4 according to an example of the disclosure.

FIG. 7 is an axonometric partial view of a rear tractive assembly of the compact tractor of FIG. 4 according to an example of the disclosure.

FIG. 8 is a detail view of the cross section of FIG. 5 showing an auxiliary power system of the compact tractor according to an example of the disclosure.

FIG. 9 is a detail view of the cross section of FIG. 5 showing a power take-off (PTO) system of the compact tractor according to an example of the disclosure.

### DETAILED DESCRIPTION

The concepts disclosed in this discussion are described and illustrated by referring to exemplary configurations. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Conventional power machines can include one or more motors (e.g., an electric motor, hydraulic motor, etc.) that are powered by one or more power sources to perform different functions of the respective power machine. However, conventional approaches typically rely on hydraulic power for a variety of functions, with corresponding complexity for packaging (e.g., relative to hydraulic equipment and flow lines) and complications for operational control. Further, these complications may be particularly notable for power machines with more complex frame arrangements (e.g., for tractors or other power machines with articulating frames).

Examples of the disclosed technology can address these or other issues. In particular, some embodiments of the disclosed technology can provide an arrangement of electric motors for a compact tractor (e.g., a compact articulated tractor) with a plurality of electric motors for tractive, auxiliary, PTO, or other operations.

In some embodiments, the frame of the compact tractor can be divided into a front portion and a rear portion, with particular motors supported on particular portions of the frame. For example, the front portion of the frame can support a front drive motor for one or more front tractive elements (e.g., front wheels or tracks), an auxiliary motor to power an auxiliary hydraulic pump, or a PTO motor to power a PTO output shaft. In contrast, the rear portion of the frame, which may be pivotable relative to the front portion relative to one or more axes, can support a rear drive motor for one or more rear tractive elements (e.g., rear wheels or tracks). Such arrangements of electric motors, for example, can provide improved organization of various elements for packaging and operation (e.g., for motors, valves, controllers, encoders, batteries, operator compartments, etc.), including within an enclosed space of the relevant frame or frame portion.

In some examples, providing separate motors to power an auxiliary pump (e.g., hydraulic pump) and a PTO system can allow motor speed to be independently varied for auxiliary and PTO operations. Thus, operational efficiency of the power machine, as well as each of the auxiliary motor and the PTO motor, can be increased. Further, control of auxiliary or PTO-powered operations can also be correspondingly improved. For example, the speed of a PTO motor can be optimized based on equipment that is connected to a shaft of the PTO system and an associated load, or otherwise variably controlled (e.g., fully independently of a corresponding auxiliary motor), or an auxiliary motor can be similarly controlled (e.g., independently of a corresponding PTO motor).

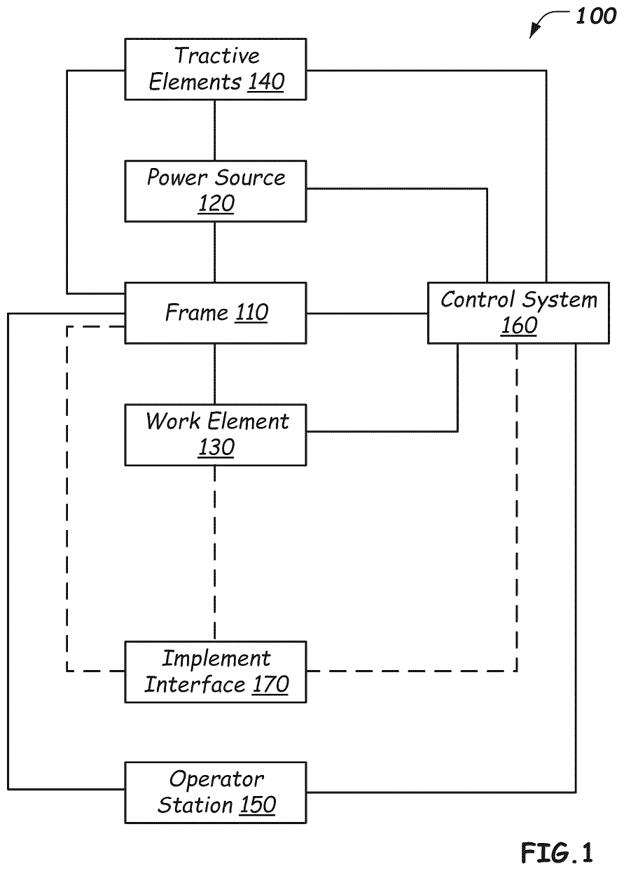

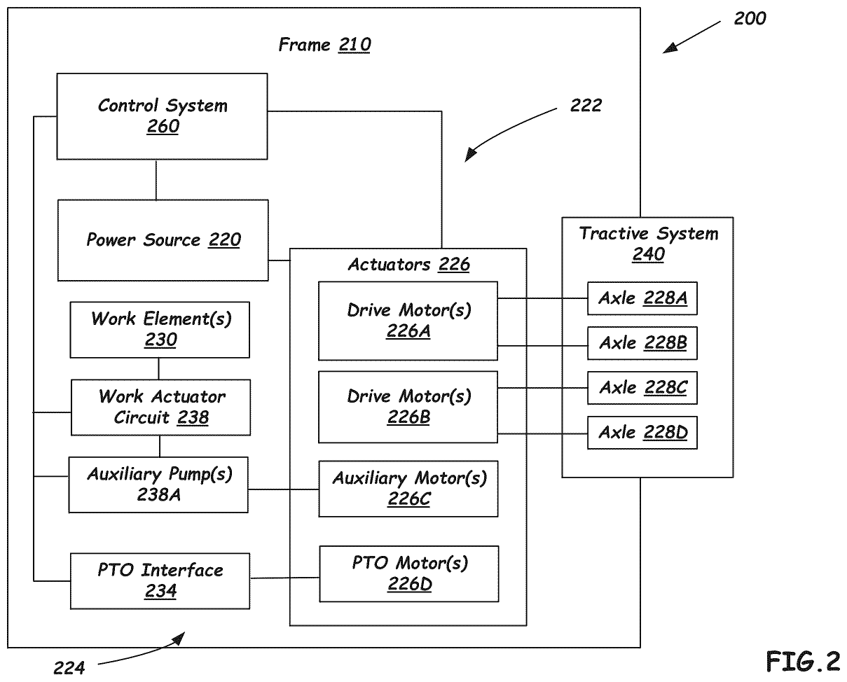

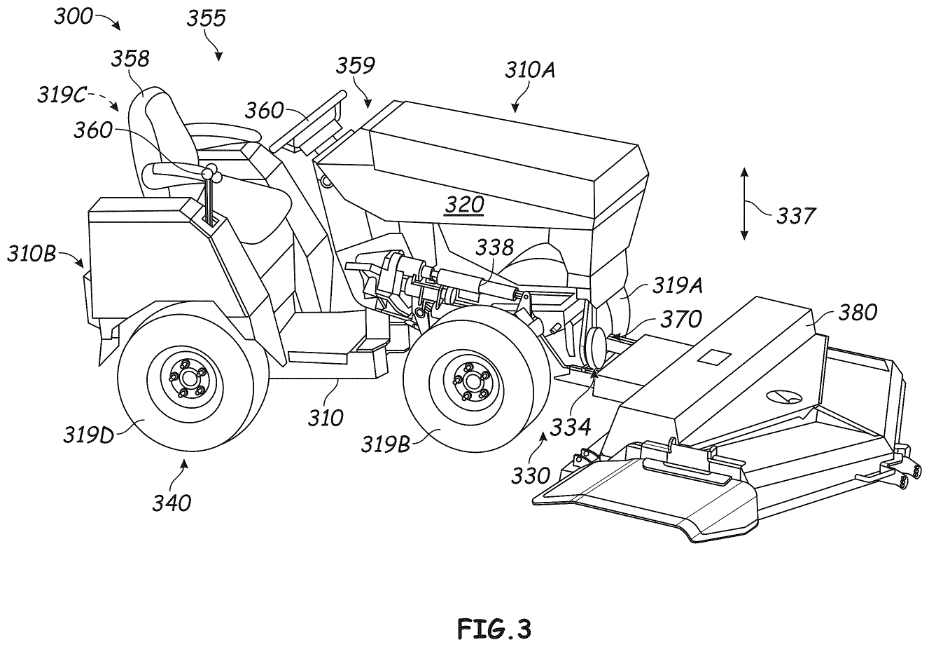

These concepts can be practiced on various power machines, as will be described below. Representative configurations of power machines on which the examples of the disclosed technology can be practiced are illustrated in diagram form in FIGS. 1 and 2, and generally illustrated in FIG. 3. For the sake of brevity, only one power machine is illustrated and discussed as being a representative power machine. However, as mentioned above, the examples below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 is a block diagram that illustrates the basic systems of a power machine 100, which can be any of a number of different types of power machines upon which the examples discussed below can be advantageously incorporated. The block diagram of FIG. 1 both identifies various systems on power machine 100 and shows relationships between various components and systems. At the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to selectively move the power machine over a support surface. The power machine also includes an operator station 150 that provides an operating position where an operator can manipulate operator inputs for controlling the work elements of the power machine (e.g., a cab, an open station with an operator seat or standing pad, etc.).

A control system 160 is provided to interact with the other systems to perform various work tasks at least in part in response to control signals provided by an operator. For example, the control system 160 can be an integrated or distributed architecture of one or more processor devices and one or more memories that are collectively configured to receive operator input or other input signals (e.g., sensor data) and to output commands accordingly for power machine operations. For example, the control system 160 can include one or more general or special-purpose electronic computers of various generally known designs. According to some examples, the control system 160 can include a hydraulic circuit provided to interact with other systems to perform various work tasks at least in part in response to signals given by an operator by way of movement of input devices arranged on the power machine 100 (e.g., within the operator station 150). Generally, the control system 160 can include or be in communication with various input devices, including operator input devices (e.g., joysticks, pedals, touchscreens, etc.), sensors distributed on or around the power machine 100, or output ports for various other components (e.g., electronic output ports of electric motors or other equipment).

Certain work vehicles have work elements 130 that can perform a dedicated task. For example, some work vehicles have a lift arm to which various implements can be attached by a pinning or other arrangement (e.g., buckets, grapples, mower decks, etc.). A lift arm, as a form of a work element, can be manipulated by various actuators to position an implement to perform a task.

Some power machines may include removable work elements, including as can be in the form of a wide variety of implements that can be attached to the power machine frame 110 via an implement interface 170. At its most basic, the implement interface 170 is a connection mechanism between the frame 110 or a work element 130 and an implement, which can be as simple as a pivoting or other connection point for attaching an implement directly to the frame 110 (or another work element 130) or can include more complex arrangements, including implement carriers.

On some power machines, the implement interface 170 can include, as an implement carrier, a physical structure movably attached to a work element (e.g., lift arm) and removably attachable to one or more implements. In this regard, the implement carrier can have engagement features and locking features to accept and secure any of a number of different implements to the work element. In some implementations, once an implement is attached to an implement carrier, the implement is fixed relative to the implement carrier so that when the implement carrier is moved with respect to the frame 110, the implement moves with the implement carrier. (The term implement carrier as used herein is not merely a pivotal connection point, but rather a dedicated device specifically intended to accept and be secured to various different implements.) An implement carrier can be mountable to a work element 130 such as a lift arm, or to the frame 110. The implement interface 170 can also include one or more power sources for providing power to one or more work elements on an implement.

Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles, including some compact tractors, have articulated frames such that one portion of the frame pivots with respect to another portion for accomplishing at least a portion of the machine movement related to steering functions.

Frame 110 supports the power source 120, which is configured to provide power to one or more work elements 130 including the one or more tractive elements 140, as well as, in some instances, providing power for use by an operably coupled implement via implement interface 170 (e.g., via one or more hydraulic connections on or near the implement interface 170). Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electrical sources or combinations of different types of power sources (e.g., electric power sources and engines), known generally as hybrid power sources.

FIG. 1 shows a single work element designated as work element 130, but various power machines can have any number of work elements. Work elements are typically attached to the frame of the power machine and movable with respect to the frame when performing a work task. In some examples, as also discussed above, work elements can include lift arm assemblies. In some examples, work elements can include mower decks or other similar equipment. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame. In contrast, workgroup work elements are configured to implement non-drive operations (e.g., moving or otherwise operating various implements).

Power machine 100 includes an operator station 150 that includes an operating position from which an operator can control operation of the power machine. In some power machines, the operator station 150 is defined by an enclosed or partially enclosed cab. Some power machines on which the disclosed technology may be practiced may not have a cab or an operator compartment of the type described above. For example, a walk behind loader may not have a cab or an operator compartment, but rather an operating position that serves as an operator station from which the power machine is properly operated. As another example, many compact tractors do not have a cab to enclose its operator station. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that is capable of controlling at least some of the operator-controlled functions on the power machine.

FIG. 2 illustrates an example of an electrically powered compact tractor 200, which is one particular example of the power machine 100 illustrated in FIG. 1. To that end, features of the tractor 200 described below include reference numbers that are generally similar to those used in FIG. 1. For example, the tractor 200 has a frame 210, just as power machine 100 has a frame 110. The tractor 200 is described herein to provide a reference for understanding one environment on which the examples described below may be practiced. The tractor 200 should not be considered limiting especially as to the description of features that tractor 200 may have described herein that are not essential to the disclosed examples and thus may or may not be included in power machines other than the tractor 200 upon which the examples disclosed below may be advantageously practiced. Unless specifically noted otherwise, examples disclosed below can be practiced on a variety of power machines, with the tractor 200 being only one of those power machines. For example, some or all of the concepts discussed below can be practiced on many other types of work vehicles such as various other loaders, excavators, trenchers, and dozers, to name but a few examples.

The frame 210 of the tractor 200 supports a power system 222 that can generate or otherwise providing power for operating various functions on the power machine. In particular, the power system 222 can include an electric power source 220 configured to supply electric power for power machine operations (e.g., a battery assembly, a generator, a capacitor system, etc.), as well as a power conversion system 224 arranged to utilize the power from the power source 220 for useful power machine operations.

In particular, the power conversion system 224 of the tractor 200 can include various components, including mechanical transmissions, hydraulic systems, various motors or other actuators, and the like. In some examples, the power conversion system 224 of the tractor 200 includes one or more electric drive motors 226A, 226B, which can be powered by the power source 220 and can be selectively controllable (e.g., via the control system 260) to provide a power to drive axles 228A-228D or other tractive assemblies of a tractive system 240. In some examples, as further discussed below, a first drive motor 226A can power a first set of axles (e.g., axles 228A, 228B) and a second drive motor 226B can power a second set of axles (e.g., axles 228C, 228D) that are connected to corresponding tractive elements (e.g., wheels or tracks, not shown in FIG. 2). However, other configurations are possible, including with a respective dedicated motor for each axle, with only front or only rear axles being powered, and so on.

The power conversion system 224 of tractor 200 also includes an auxiliary motor 226C that can be powered by the power source 220 and controlled by the control system 260 to provide rotational power to one or more corresponding auxiliary pumps 238A. The auxiliary pumps 238A can thus be operated, using electric power from the power source 220, to provide hydraulic flow for various power machine functions. In particular, for example, the auxiliary pump(s) 238A may provide hydraulic flow to a work actuator circuit 238 that can be configured to operate a lift arm, implement, or other work element 230 (e.g., using various known hydraulic valves, actuators, controllers, and so on).

In some cases, the actuators 226 of the power conversion system 224 can include one or more power take-off (PTO) motors 226D. For example, the PTO motor(s) 226D can be operated using power from the power source 220, as controlled by the control system 260, to provide rotational power to an output shaft or other form of PTO interface 234.

FIG. 3 illustrates an example compact tractor 300, which is one particular example of a power machine 100 of FIG. 1 or the tractor 200 of FIG. 2, where the examples discussed below can be advantageously employed. To that end, features of the tractor 300 described below include reference numbers that are generally similar to those used in FIGS. 1 and 2 and discussion of above applies to similar numbers below unless otherwise noted or required. For example, the tractor 300 is described as having a frame 310, just as power machine 100 has a frame 110. However, the tractor 300 as illustrated should not be considered limiting, and examples disclosed below can also be practiced on a variety of other power machines.

The frame 310 of the tractor 300 supports a power system 320 that is capable of generating or otherwise providing power for operating various functions on the power machine. In particular, the power system 320 can include an electric power source (e.g., a battery assembly) in some examples. Power system 320 is shown in block diagram form and is located within the frame 310 so as not visible in FIG. 3. In particular, the frame 310 can be an articulating frame. Accordingly, a front frame portion 310A supported by front wheels 319A, 319B can be moved along one or more degrees of freedom (e.g., pivoted about a vertical or a horizontal axis) relative to a rear frame portion 310B supported by the rear wheels 319C, 319D (wheel 319C hidden from view in FIG. 3). In other examples, however, non-articulated or differently articulated frames can be used.

The frame 310 also supports a work element in the form of a lift arm assembly 330 that is powered by the power system 320 and that can perform various work tasks. As the tractor 300 is a work vehicle, the frame 310 also supports a traction system 340, which is also powered by power system 320 and can propel the power machine over a support surface. The lift arm assembly 330 in turn supports an implement (e.g., accessory) interface 370 that can receive and secure various implements to the tractor 300 for performing various work tasks. In some examples, the implement interface 370 (or other sub-system) can include power couplers, to which an implement can be coupled to receive hydraulic or electric power from the power system 320. In some examples, a PTO interface 334 can be provided (e.g., a pully-operated output shaft). Power couplers can provide sources of hydraulic or electric power or both.

The tractor 300 includes an operator station 355 from which an operator can manipulate various control devices 360 to cause the tractor 300 to perform various work functions. In the illustrated example, the operator station 355 includes an operator seat 358 and a plurality of operation input devices, including control levers and a steering wheel (e.g., control devices 360) that an operator can manipulate to control various machine functions, including as steering functions, drive functions, and auxiliary hydraulic functions (i.e., pressurized hydraulic flow made selectively available to an operably coupled implement). Operator input devices can include various human-machine interfaces including buttons, switches, levers, sliders, pedals, touchscreens, and the like that can be stand-alone devices such as hand-operated levers or foot-operated pedals, incorporated into hand grips, or incorporated into display panels, which may be included on the dashboard 359, including programmable input devices. Actuation of operator input devices can generate signals in the form of electrical signals, hydraulic signals, or mechanical signals. Signals generated in response to operator input devices are provided to various components on the power machine for controlling various functions on the power machine (e.g., to or via one or more electronic controllers of a larger electronic control system). Among the functions that can be controlled via operator input devices on tractor 300 include control of the tractive elements 319, the lift arm assembly 330, the implement interface 370, and providing signals to any implement that may be operably coupled to the implement.

Other power machines, including walk behind power machines may not have a cab nor an operator compartment, nor a seat. The operator position on such power machines is generally defined relative to a position where an operator can access and manipulate relevant operator input devices.

Various power machines that can include or interacting with the examples discussed below can have various different frame components that support various work elements. The frame 310 discussed herein can include many elements, however the frame 310 is not the only type of frame that a power machine on which the disclosed technology can be practiced can employ. For example, the frame 310 of tractor 300 can include an undercarriage or lower portion of the frame 310 and a mainframe or upper portion of the frame 310 that is supported by the undercarriage. The mainframe of tractor 300, in some examples is attached to the undercarriage such as with fasteners or by welding the undercarriage to the mainframe. Alternatively, the mainframe and undercarriage can be integrally formed. The frame 310 also supports a set of tractive elements in the form of the wheels 319A-D at the front and back of both sides of the tractor 300.

The lift arm assembly 330 shown in FIG. 3 is one example of many different types of lift arm assemblies that can be attached to a power machine such as tractor 300 or other power machines on which examples of the present discussion can be practiced. The lift arm assembly 330 is moveable using actuators 338 (e.g., hydraulic cylinders), to change position of the lift arm assembly 330 along a lift path 337 with respect to the frame 310 (e.g., extending and retracting to raise and lower the lift arm assembly as desired). Other lift arm assemblies can have different geometries and can be coupled to the frame of a loader in various ways to provide lift paths. For example, some lift arm assemblies are configured to provide a vertical lift path, while others are configured to provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

Some lift arms, most notably lift arms on excavators but also possible on loaders, may have portions that are controllable to pivot with respect to another segment instead of moving in concert (i.e., along a pre-determined path). Some power machines have lift arm assemblies with a single lift arm, such as is known in excavators or even some loaders and other power machines. Other power machines can have a plurality of lift arm assemblies, each being independent of the other(s), or a variety of other work elements.

Generally, implements can be located generally forward of a front of the tractor 300 (or at other locations), including implements that include or provide any suitable accessory for the tractor 300. For example, an implement 380 can be configured as a lawn mower deck (e.g., as shown), a snow blower, a trench digger, a sweeper, a plow, a dump bucket, a hole digger, a chipper, and an aerator, but is not so limited and may be nearly any variety of accessory that may be utilized and/or driven by the tractor 300. Generally, implements have a complementary machine interface that is configured to be engaged with the implement interface 370 in an operational configuration. Further, various implement power couplers can be included to provide hydraulic or electrical signals to or from an associated implement (e.g., the implement 380).

The description of power machine 100 and tractors 200, 300 above is provided for illustrative purposes, to provide illustrative environments on which the examples discussed below can be practiced. While the examples discussed can be practiced on a power machine such as is generally described by the power machine 100 shown in the block diagram of FIG. 1 and more particularly on a compact tractor such as the tractors 200, 300, unless otherwise noted or recited, the concepts discussed below are not intended to be limited in their application to the environments specifically described above.

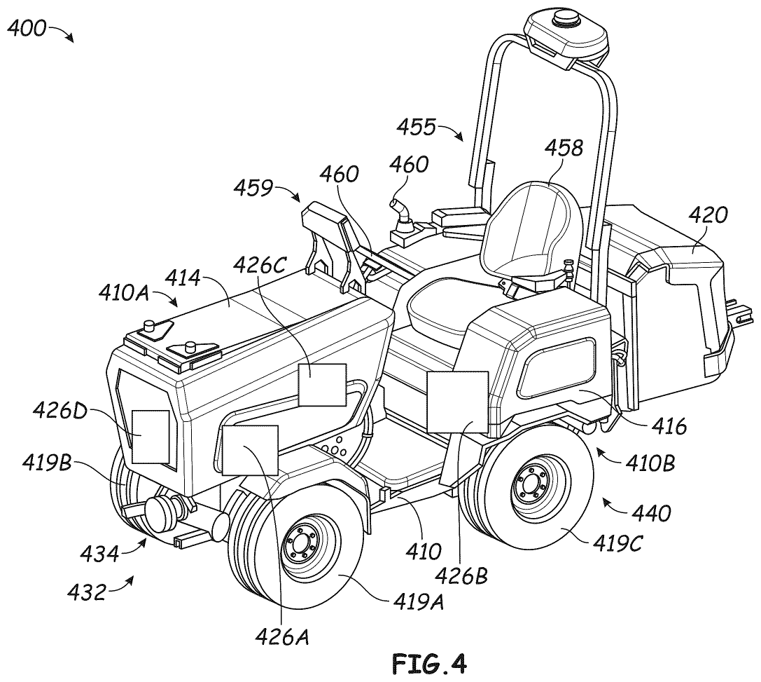

As mentioned above, examples of the disclosed technology can provide an arrangement of electric motors for a compact tractor, thereby providing an improved organization of various elements for packaging and improved operation of the compact tractor overall. For example, FIG. 4 illustrates an example compact tractor 400, which is another particular example of the power machine 100 of FIG. 1, the tractor 200 of FIG. 2, or the tractor 300 of FIG. 3. To that end, features of the tractor 400 described below include reference numbers that are generally similar to those used in FIGS. 1-3. For example, the tractor 400 is described as having a frame 410, just as power machine 100 has a frame 110. Correspondingly, discussion of numbered components above also applies to correspondingly numbered components below, unless otherwise noted or required. However, the tractor 400 as illustrated should not be considered limiting, and examples disclosed below can also be practiced on a variety of other power machines.

In the illustrated example, the frame 410 is an articulating frame with a front frame portion 410A that can be moved along one or more degrees of freedom relative to a rear frame portion 410B. For example, the front frame portion 410A can articulate relative to the rear frame portion 410B (e.g., pivot about a vertical or a horizontal axis) about an articulating joint that links the front frame portion 410A and the rear frame portion 410B (e.g., an articulating joint between the frame portions 410A, 410B, hidden from view in FIG. 3).

As shown in FIG. 4, the frame 410 of the tractor 400 supports a power source 420 that is capable of generating or otherwise providing power for various functions of the tractor 400 (e.g., tractive and work functions, as further detailed above and below). In particular, the power source 420 can include an electric power source in some examples (e.g., a battery assembly, a capacitor, a hydrogen fuel cell, an ethanol fuel cell, a methanol fuel cell, a solar panel, etc.). The power source 420 is supported by the frame 410, in the illustrated example, is mounted to the rear frame portion 410B. Correspondingly, in the illustrated example, the power source 420 located rearward of an operator station 455, which can include an operator seat 458 and a plurality of operational input devices to control various work functions of the tractor 400 (e.g., control devices 460, or human-machine interfaces included a touchscreen 459 or other display, etc.).

More specifically, the power system 420 can be operated to power a plurality of electric motors that are supported on separate portions of the frame 410 for separate purposes. As the tractor 400 is a work vehicle, the frame 410 also supports a traction system 440, which is also powered by the power system 420 and can propel the tractor 400 over a support surface (e.g., outdoor terrain). The traction system 440 can include front tractive elements 419A, 419B that are supported by the front frame portion 410A and rear tractive elements 419C, 419D that are supported by the rear frame portion 410B. In the illustrated example, the front tractive elements 419A, 419B are steerable wheels that are attached to a front transaxle (not shown in FIG. 4) and the rear tractive elements 419C, 419D are attached to a rear transaxle (not shown in FIG. 4). In other examples, however, tractive element can be configured to be independently operable (e.g., for skid steering), and non-wheel tractive elements, including track assemblies, are also possible.

Further, in the illustrated example, the tractive system 440 of the tractor 400 includes a plurality of electric motors that are supported by the frame 410. For example, one or more of the front tractive elements 419A, 419B can be powered by a front drive motor 426A (e.g., a first drive motor that is mounted to the front transaxle). The front drive motor 426A can be positioned within a front housing 414 of the tractor 400 and can be supported on the front frame portion 410A. Similarly, one or more of the rear tractive elements 419C, 419D can be powered by a rear drive motor 426B (e.g., a second drive motor that is mounted to the rear transaxle). The rear drive motor 426B can be positioned within a rear housing 416 of the tractor 400 and can be supported by the rear frame portion 410B. In some examples, the rear drive motor 426B can be arranged below at least a portion of the operator seat 458, which can provide both efficiency in usage of space and help to separate or shield the motor 426B from the environment and associated contaminants or debris. In some examples, height of the operator seat 458 can be adjusted (e.g., raised or lowered) while still accommodating the rear drive motor 426B and other elements within the rear frame portion 410B, or may be movable (e.g., tiltable relative to the rear frame portion 410B to allow access to the rear drive motor 426B).

In some examples, the tractive system 440 can include one or more motors that can each independently power rotation of a corresponding tractive element. For example, the tractive system 440 can further include a third drive motor (not shown in FIG. 4) and a fourth drive motor (not shown in FIG. 4), and each of the four drive motors can control a corresponding one of the four tractive elements 419A-419D. For example, the front drive motor 426A can power the front wheel 419A, the rear drive motor 426B can power the rear wheel 419C, the third drive motor can power the front wheel 419B, and the fourth drive motor can power the rear wheel 419D. Further, combinations with other numbers of drive motors are possible. For example, two drive motors can independently power respective ones of the front tractive elements 419A, 419B, and one drive motor can power both of the rear tractive elements 419C, 419D. Alternatively, one drive motor can power both of the front tractive elements 419A, 419B, and two drive motors can independently power respective ones of the rear tractive elements 419C, 419D.

Continuing, the frame 410 can support an auxiliary motor 426C to power auxiliary (non-drive) operations. For example, the auxiliary motor 426C can be supported by the front frame portion 410A to power a hydraulic pump (not shown in FIG. 4) that is also supported by the front frame portion 410A. The hydraulic pump can thus power various hydraulic operations for the tractor 400 (e.g., powering a hydraulic power steering system, or operating a lift arm or other hydraulically powered implement). Although the auxiliary motor 426C is supported by the front frame portion 410A and is positioned within the front housing 414 in the illustrated example, the auxiliary motor 426C can be supported by the rear frame portion 410B in other configurations.

Further, the frame 410 can be configured to support a work element in the form of a lift arm assembly (not shown in FIG. 4) that is powered by the power system 420 and that can perform various work tasks. The lift arm assembly can support an implement (e.g., accessory) interface that can receive and secure various implements to the tractor 400 for performing various work tasks. In some examples, the implement interface (or other sub-system) can include power couplers, to which an implement can be coupled to receive hydraulic or electric power from the power system 420.

In some examples, a PTO assembly 432 can include a PTO interface 434, to provide power to a lift arm assembly or various other components external to the tractor 400. As detailed below, for example, the PTO interface 434 can include a pully-operated output shaft or various other known power-transfer systems.

More specifically, a lift arm assembly or other PTO-attached assembly can be powered, via the PTO interface 434, by a PTO motor 426D of the PTO assembly 432 that is supported by the frame 410. As noted above, for example, power can be transferred from the PTO motor 426D to an output shaft (or socket) of the PTO interface 434 via a belt-and-pully system of the PTO assembly 432, or in various other ways, to perform work functions with various implements that are coupled the PTO interface 434. In the illustrated example, the PTO motor 426D is supported by the front frame portion 410A and is positioned within the front housing 414, although other configurations are possible (e.g., to facilitate different locations for the PTO interface 434).

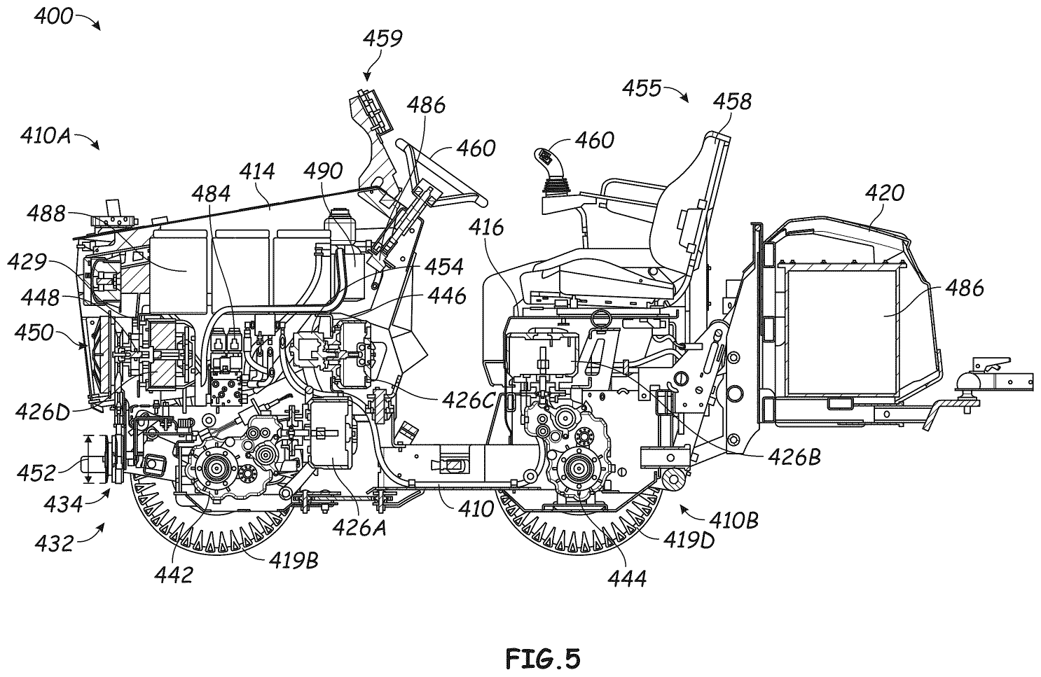

Referring now to FIGS. 5-9, further details of an example configuration of the motor arrangement of the compact tractor 400 are shown, according to examples of the present disclosure. In this regard, some implementations of the tractor 400 as discussed above may vary relative to one or more particular details of the internal structures and components as shown in FIGS. 5-9.

FIG. 5 shows a particularly useful arrangement of electric motors for the compact tractor 400, including the front drive motor 426A, the rear drive motor 426B, the auxiliary motor 426C, and the PTO motor 426D. More specifically, the front frame member 410A of the frame 410 the front drive motor 426A, the auxiliary motor 426C, and the PTO motor 426D, as well as the front housing 414 (e.g., a hood, etc.) that at least partially encloses these components. The front drive motor 426A is disposed adjacent to but rearward of a rotational axis of the front tractive elements 419A, 419B, as further detailed below.

Continuing, the auxiliary motor 426C is positioned above the front drive motor 426A, to power an auxiliary pump 454, with a corresponding arrangement of flow conduits (e.g., hoses) that connect the auxiliary pump 454 to other parts of the auxiliary hydraulic system (e.g., a tank or reservoir, various hydraulic actuators, etc.). In some cases, one or more (e.g., all) of these other parts of the auxiliary hydraulic system may be supported by the front frame member 410A, within the front housing 414.

Additionally, the PTO motor 426D is disposed toward front of the front housing 414, near the PTO interface 434. As further detailed below, the PTO motor 426D can be offset relative to the PTO interface 434 (e.g., vertically offset, as shown). Correspondingly, a belt-driven or other power transfer system (e.g., a chain drive system, a rope drive system, a gear drive system, a slew drive system, etc.) can be provided to transmit rotational power from the PTO motor 426D to the PTO interface 434.

In some examples, the front housing 414 can include other features, including a valve block 484 for control of various hydraulic functions (e.g., an electrohydraulic valve block), one or more electronic controllers (e.g., a motor controller, not shown), a steering encoder 486, one or more onboard batteries 488 (e.g., for supplemental power), an expansion tank 490, the various flow conduits mentioned above, and so on. In this regard, the illustrated arrangement of the various motors 426A, 426C, 426D and related components within the front housing 414 can provide a relatively compact overall assembly, with improved organization and utilization of available space of the front housing 414 as compared to conventional approaches. However, in other configurations, other arrangements of one or more of the noted components are possible.

As also shown in FIG. 5, the rear frame portion 410B supports the rear drive motor 426B within the rear housing 416. In particular, the rear drive motor 426B is disposed adjacent to but vertically above a rotational axis of the rear tractive elements 419C, 419D. The rear housing 416 can further include other vehicle parts, including chargers (not shown) for a main battery assembly 492 of the power source 420 (e.g., a swappable power source 420, as shown), one or more electronic controllers (not shown) (e.g., for motors or autonomous vehicle operation), a power distribution unit (not shown), and so on. In this regard, the illustrated arrangement of the motor 426B and related components within the rear housing 416 can also provide a relatively compact overall assembly, with improved organization and utilization of available space of the rear housing 416 as compared to conventional approaches. However, in other configurations, different arrangements of one or more of the noted components are possible.

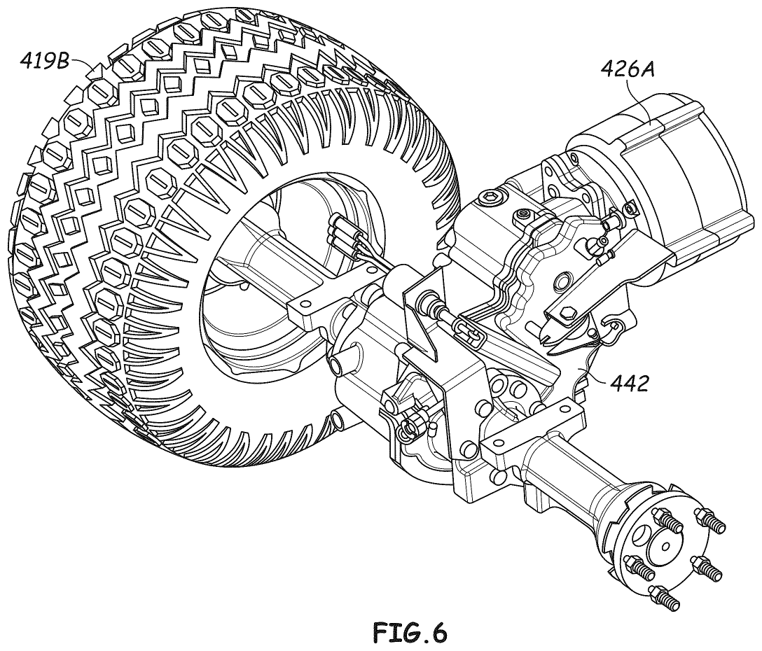

Referring to FIG. 6 in particular, the front drive motor 426A can engage with a front transaxle 442, which is supported by the front frame portion 410A (shown in FIG. 5). Thus, the front drive motor 426A can provide power to the front tractive element 419A on a first lateral side of the tractor 400 (see FIG. 4) and to the front tractive element 419B on a second lateral side of the tractor.

In the illustrated example, the front drive motor 426A is mounted to the front transaxle 442, and thus supported by front transaxle 442 relative to the front frame portion 410A. In some examples, the front drive motor 426A can be generally centered between the first front tractive element 419A and the second front tractive element 419B (i.e., spaced apart from a centerline of the tractor 400 by 10% or less of the total distance between the tractive elements 419A,B). Further, a rotational axis and housing of the front drive motor 426A extends rearward of the front transaxle 442, relative to a front-to-back direction of the tractor 400. Correspondingly, the front drive motor 426A is offset rearwardly (and vertically, as shown) relative to the axes of rotation of the front tractive elements 419A, 419B. As well as providing favorable orientations relative to component packaging, this arrangement can provide improved vehicle mass distribution and allow for improved access to the various drive components, and to the assembly as a whole, for service or other operations (e.g., electronic diagnostics).

In some cases, with similar benefits as noted above, the front drive motor 426A is cantilevered from the front transaxle 442 and a rotational axis of the motor 426A extends horizontally from the front transaxle 442 toward the rear of the front frame portion 410A. However, a mounting orientation for a drive motor can be different in some examples, including as may depend on an amount of available space of the front housing 414 or the need to accommodate other vehicle parts. For example, in other implementations, the front drive motor 426A can extend toward front of the front frame portion 410A. In some examples, the first drive motor 426A can be mounted so that a rotational axis of the motor 426A extends vertically (e.g., toward top or bottom of the front frame portion 410A). Further, in some cases, each of the front tractive elements 419A, 419B can be provided with a drive motor, and the tractive system 440 may correspondingly not include a transaxle. With such an arrangement, for example, the front housing 414 may have even more available space for other components.

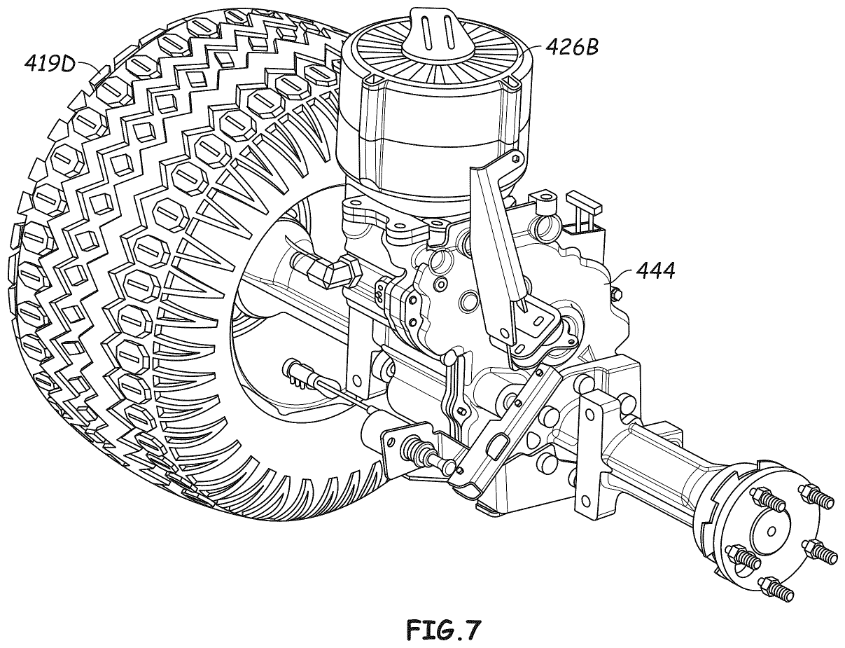

Referring now to FIG. 7, the rear drive motor 426B can engage with a rear transaxle 444, which is supported by the rear frame portion 410B (shown in FIG. 5). Thus, the rear drive motor 426B can provide power to the rear tractive element 419C (see FIG. 4) on the first lateral side of the tractor and the rear tractive element 419D on the second lateral side of the tractor 400.

In the illustrated example, the rear drive motor 426B is mounted to the rear transaxle 444, and thus supported by rear transaxle 444 relative to the rear frame portion 410B. In some examples, including as shown, the rear drive motor 426B is generally centered between the first rear tractive element 419C and the second rear tractive element 419D (i.e., spaced apart from a centerline of the tractor 400 by 10% or less of the total distance between the tractive elements 419C,D). Further, a rotational axis (and housing) of the rear drive motor 426B generally extends vertically upward from the rear transaxle 444. Correspondingly, the rear drive motor 426B is offset vertically (and forwardly, as shown) relative to the axes of rotation of the rear tractive elements 419C, 419D. In some cases, including as shown, the rear drive motor 426B can be cantilevered from the rear transaxle 444. As similarly discussed above, this arrangement can provide favorable orientations relative to component packaging, improved vehicle mass distribution, improved access to the various drive components, and to the assembly as a whole.

As also noted relative to the front drive motor 426A, a mounting orientation for the rear drive motor 426B can be different in other examples, including as may depend on an amount of available space of the rear housing 416 or the need to accommodate other vehicle parts. In some cases, the rear drive motor 426B be cantilevered from the rear transaxle 444 to extend horizontally toward the front or the back of the rear frame portion 410B. Further, in some cases, each of the rear tractive elements 419C, 419D can be provided with a drive motor, and the tractive system 440 may correspondingly not include a transaxle. With such an arrangement, for example, the rear housing 416 may have even more available space for other components.

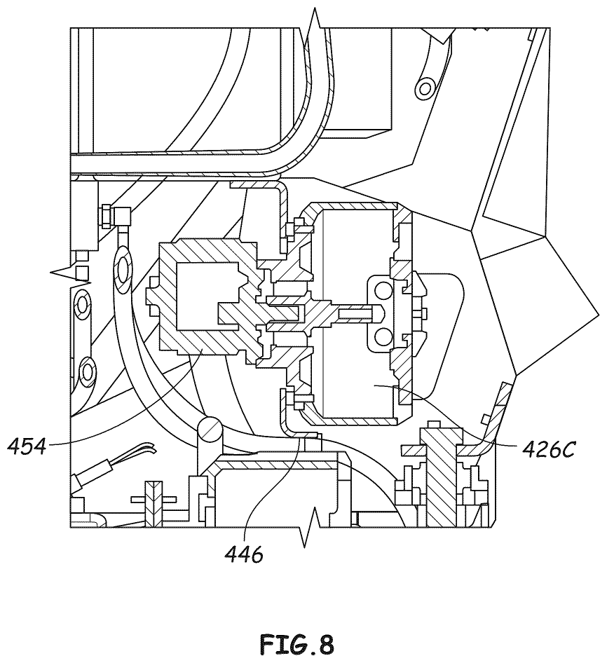

FIG. 8 illustrates an example configuration in which the auxiliary motor 426C is mounted with a flange 446. In particular as shown, the flange 446 can support the auxiliary motor 426C with an axis of rotation arranged horizontally and above the drive motor 426A (see FIG. 5), although other configurations are possible. Thus supported, as also discussed above, the auxiliary motor 426C can power the hydraulic pump 454 to deliver hydraulic fluid for auxiliary functions of the tractor 400 (e.g., power steering, etc.). As with other motors discussed above, the auxiliary motor 426C can be configured differently in some examples, including with the auxiliary motor 426C otherwise located within the front housing 414 and supported by the front frame member 410A.

Of note, with the illustrated arrangement, the auxiliary motor 426C can be controlled for operation independent of other motors (e.g., the PTO motor 426D, as discussed below), including with active control based on the demands of the hydraulic system (e.g., as determined based on operator input or sensor data). Further, the auxiliary motor 426C can be turned on and off as needed (e.g., rather than operating continuously as a rotational sink directly powered by an engine). Accordingly, in addition to other benefits discussed above, inclusion of the auxiliary motor 426C as an independently controllable motor can provide improved efficiency and operator control as compared to conventional systems.

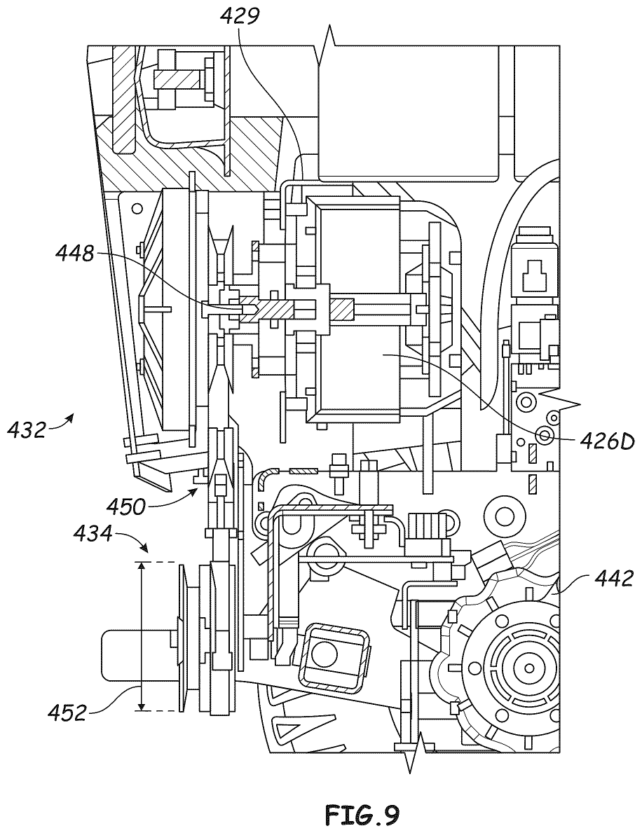

As shown in FIG. 9, the PTO motor 426D also can be mounted horizontally (e.g., to a flange 429), although other configurations are possible. In the example shown, the PTO motor 426D powers a PTO output shaft 448 at the power the PTO interface 434 via a PTO pulley system 450. As generally known in the art, the PTO interface 434 can be used to support various attachments and thus make power from the PTO motor 426D available for various operations. Use of a pulley system, for example, can allow for a beneficial radial offset between the axes of the PTO motor 426D and the PTO output shaft 448, as well as imposition of speed reduction as appropriate.

In some cases, a pulley diameter 452 of the PTO interface 434 can be selected to optimize particular operation conditions (e.g., PTO output speed range, relative to motor capabilities). In some cases, the pulley diameter 452 can be selected based on a maximum rotational speed of the PTO motor 426D (e.g., for the most efficient operation of the PTO motor 426D in combination with a useful range of output rotational speeds at the PTO interface 434). In the present example, the PTO pulley system 450 includes two pulleys that are each V-type idler pulleys. However, other types of pulleys are possible, including a hitch arm pulley and other forms of an idler pulley, and other numbers of pulleys can also be used.

Of note, with the illustrated arrangement, the PTO motor 426D can also be controlled for operation independent of other motors (e.g., the auxiliary motor 426C), including with active control based on the demands of a particular PTO implement or operation. Thus, for example, in contrast to conventional systems, PTO motor speed can be optimized relative to the needs of a particular function, including lower-speed functions (e.g., operating a fan), higher-speed functions (e.g., mowing), and others with intermediate speed requirements (e.g., tilling and trenching). In some examples, the PTO motor 426D can be controlled via user input at the touchscreen 459 (see FIG. 5) or other operator interface, or can be automatically controlled (e.g., based on a detected or input type of an implement attached at the PTO interface 434). Further, operation of the PTO motor 426D (or the auxiliary motor 426C) can be moderated depending on power requirements of other systems, or operation of other motors (e.g., the drive motors 426A, 426B can be moderated depending on power demand at the PTO interface 434. For example, for some operations, power delivery to the PTO motor 426D (or the auxiliary motor 426C) can be prioritized over power delivery to the drive motors 426A, 426B, or vice versa.

Further in this regard, some configurations can provide notable improvements over existing systems because that the PTO motor 426D can be controlled independently from the auxiliary motor 426C. Conventionally, PTO and auxiliary functions may be powered directly by a crank shaft of an internal combustion engine and thus operate with speeds that are linked to each other and to the operation of the engine. By providing separate motors for the PTO assembly 432 and the auxiliary system, the present design allows motor operations to be individually controlled to power respective system more efficiently. Further, because the PTO motor 426D and the auxiliary motor 426C are not directly powered by an internal combustion engine, it is possible to conserve energy by operating the motors 426C, 426D only when needed and without requiring engagement or disengagement of a clutch, which can itself add complexity and further power requirements.

Although the presently disclosed technology has been described by referring preferred examples, workers skilled in the art will recognize that changes may be made in form and detail without departing from the scope of the discussion. In this regard, details presented relative to any of the examples discussed herein can be implemented independently or in various combinations (e.g., with aspects of any one of the motors 426A-D implemented independently or in combination with aspects of any one or more other of the motors 426A-D).

As used herein in the context of a power machine, unless otherwise defined or limited, the term “lateral” refers to a direction that extends at least partly to a left or a right side of a front-to-back reference line defined by the power machine. Accordingly, for example, a lateral side wall of a cab of a power machine can be a left side wall or a right side wall of the cab, relative to a frame of reference of an operator who is within the cab and is oriented to operatively engage with controls of an operator station of the cab.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

As used herein in the context of electronic control systems, unless otherwise specified or limited, the term “module” is intended to encompass generally known hardware devices, software tools, and combinations thereof for electronic control systems that can be configured or customized to implement particular functionality. For example, a module may include a variety of known circuitry or electrical components that can be configured for controlled powered operation of actuators, including general or special purpose processor devices, motor drives, field programmable devices, executable instructions on computer readable media, and so on.

1. A tractor comprising:
a frame that includes a front frame portion and a rear frame portion that articulates relative to the front frame portion;
an electric power source supported by the frame;
tractive elements supported by the frame and configured to operate to move the tractor over terrain, including front tractive elements supported by the front frame portion and rear tractive elements supported by the rear frame portion; and
a plurality of electric motors supported by the frame, including:
a first drive motor arranged to power one or more of the front tractive elements; and
a second drive motor arranged to power one or more of the rear tractive elements.

2. The tractor of claim 1, wherein the first drive motor is engaged with a front transaxle supported by the front frame portion, to provide power to a first front tractive element on a first lateral side of the tractor and a second tractive element on a second lateral side of the tractor.

3. The tractor of claim 2, wherein the first drive motor extends rearward of the front transaxle, relative to a front-to-back direction of the tractor.

4. The tractor of claim 3, wherein the first drive motor is cantilevered from the front transaxle.

5. The tractor of claim 2, wherein the second drive motor is engaged with a rear transaxle supported by the rear frame portion, to provide power to a first rear tractive element on the first lateral side of the tractor and a second rear tractive element on the second lateral side of the tractor.

6. The tractor of claim 5, wherein the second drive motor extends above the rear transaxle.

7. The tractor of claim 6, wherein the second drive motor is arranged between the rear transaxle and an operator seat supported by the rear frame portion, with the second drive motor arranged below at least part of the operator seat.

8. The tractor of claim 1, wherein the plurality of electric motors further includes a third drive motor and a fourth drive motor; and
wherein:
the first drive motor is arranged to power a first front tractive element of the front tractive elements;
the second drive motor is arranged to power a first rear tractive element of the rear tractive elements;
the third drive motor is arranged to power a second front tractive element of the front tractive elements; and
the fourth drive motor is arranged to power a second rear tractive element of the rear tractive elements.

9. The tractor of claim 1, wherein the plurality of electric motors further includes one or more of:
a power take-off (PTO) motor arranged to power a PTO assembly supported by the frame; or
an auxiliary motor arranged to power a hydraulic pump supported by the frame to power hydraulic operations for the tractor.

10. The tractor of claim 9, wherein the plurality of electric motors includes the PTO motor and the auxiliary motor;
wherein the first drive motor, the PTO motor, and the auxiliary motor are mounted to the front frame portion; and
wherein the second drive motor is mounted to the rear frame portion.

11. A method of operating a power machine, the method comprising:
operating an electric power source supported by a frame of the power machine to power a plurality of electric motors supported by the frame, including a first drive motor and a second drive motor, the frame including a front frame portion and a rear frame portion that articulates relative to the front frame portion; and
controlling the first drive motor, with the first drive motor powered by the electric power source, to power one or more front tractive elements supported on the front frame portion of the frame and controlling the second drive motor, with the second drive motor powered by the electric power source, to power one or more rear tractive elements supported on the rear frame portion, to move the power machine over terrain.

12. The method of claim 11, wherein the plurality of electric motors further includes one or more of:
a power take-off (PTO) motor arranged to power a PTO assembly supported by the frame; or
an auxiliary motor arranged to power a hydraulic pump supported by the frame to power hydraulic operations for the power machine; and
wherein the method further includes controlling the one or more of the PTO motor or the auxiliary motor to operate with variable speed, under power from the electric power source, to provide, respectively, one or more of a variable speed PTO output at the PTO assembly or variable speed operation of the hydraulic pump.

13. The method of claim 12, wherein controlling the one or more of the PTO motor or the auxiliary motor includes operating the PTO motor or the auxiliary motor independently of the first drive motor or the second drive motor.

14. The method of claim 13, wherein controlling the one or more of the PTO motor or the auxiliary motor includes operating the PTO motor independently of the auxiliary motor.

15. The method of claim 11, wherein controlling the first drive motor includes operating the first drive motor to rotate about an axis that extends in a front-to-rear direction, with the first drive motor cantilevered from a front transaxle supported on the front frame portion, and
wherein controlling the second drive motor includes operating the second drive motor to rotate about an axis that extends upwardly, with the second drive motor cantilevered from a rear transaxle supported on the rear frame portion.

16. A power machine comprising:
a frame including a first frame portion and a second frame portion that articulates relative to the first frame portion;
an electric power source supported by the frame;
a first transaxle supported by the first frame portion;
a second transaxle supported by the second frame portion;
a first electric motor supported by the first frame portion and cantilevered from the first transaxle to provide power to the first transaxle; and
a second electric motor supported by the second frame portion and cantilevered from the second transaxle to provide power to the second transaxle.

17. The power machine of claim 16 further comprising:
a power take-off (PTO) assembly supported by the frame, including a PTO interface and a PTO motor configured to provide power to the PTO interface.

18. The power machine of claim 17 further comprising:
a hydraulic pump supported by the frame; and
an auxiliary motor configured to power the hydraulic pump,
wherein the auxiliary motor operates independently of one or more of the PTO motor, the first electric motor, or the second electric motor.

19. The power machine of claim 18, wherein the PTO motor and the auxiliary motor are supported by the first frame portion.

20. The power machine of claim 17, wherein the PTO assembly includes a pulley system.
